(19) United States
(12) Patent Application Publication
(10) Pub. No.: US 2006/0117055 A1
(43) Pub. Date: Jun. 1, 2006

(54) Client-based web server application verification and testing system

(76) Inventor: John Doyle, Timonium, MD (US)

Correspondence Address: Royal W. Craig;Law Offices of Royal W. Craig, Suite 153, 10 N. Calvert Street, Baltimore, MD, 21202, US

(21) Appl. No.: 10/998,871

(22) Filed: Nov. 29, 2004

(51) Int. Cl. G06F 9/44; G06F 7/00

(52) U.S. Cl. 707/102; 717/100

(57) ABSTRACT

A client-based web server application verification and testing system that requires no technical training, yet provides effective and efficient automated testing. The invention facilitates the rapid generation of test cases for a web site, and the automated execution of those test cases via distributed computing. The transitions through a web site are mapped onto a tree control to exploit user familiarity with a dual pane graphical interface and the drag/drop operation on tree controls. The tree is populated primarily by an autonomous spider exploring the site. Complex sequences requiring form inputs are added by recording sample sequences and then allowing the user to prune from all possible permutations of those samples. The export and import of form input data to a spreadsheet provides additional flexibility. Both the exploration and validation tasks may be distributed to a network of computers.

### BACKGROUND OF THE INVENTION

1. Field of the Invention

The present invention relates to Internet testing tools and, more particularly, to systems and methods for client-based web server application verification and testing.

2. Description of the Background

The techniques for the automated testing of web sites fall into three categories: autonomous programs called spiders that explore a site by following each link on a page, robotic browsers that record and playback keystrokes and mouse movements (or their equivalent browser actions), and script driven or custom written browser emulators. All of these have distinct advantages and all might be employed to test different aspects of the web site. Spiders are useful for frequent checks of operational sites and partial regression testing during the development cycle. Robots are useful for capturing complex sequences involving form data inputs. Browser emulators are often used to replay sequences at high frequency for load testing. They are also used to apply different data values for form inputs to exercise different processing paths in the web site application. The scripts for emulators may be generated by processing a recording session similar to a robot's. Distributed execution of all of these programs can greatly reduce the time required to complete a set of tests.

Because it evolved from many years of client-server system testing, web site testing is a mature discipline with well accepted practices and products supporting those practices. The products usually require specialized training, making web testing a technical discipline. Web development, however, is still seeing constant improvements in efficient and easy to use tools. Many websites are developed by non-programmers with little or no technical training. This imbalance has caused testing to become a greater portion of the total cost of deploying and maintaining web sites. Consequently, many web sites are insufficiently tested before release to production.

Web Site Testing and/or monitoring tools are well known in the prior art. For example, U.S. Pat. No. 6,738,813 to Reichman discloses a monitoring system that provides a service for users to monitor their respective Web sites, or other server systems, as seen from the computing devices of other users. In a preferred embodiment, the system includes an agent component that runs on the computing devices of service users to provide functionality for accessing and monitoring the performance of a server. The agents are remotely configurable over the Internet, and may be configured to execute a particular Web transaction while monitoring specified performance parameters (server response times, network hop delays, server availability, etc).

U.S. Pat. No. 6,631,408 to Welter, et al. discloses a method for testing a web site that includes formulating a test configuration file including a series of test inquiries for a web site to be tested, initiating a HTTP communication to form a connection with the web site, and repetitively communicating with the web site to test for a variety of errors. The method includes receiving HTML from the web site, analyzing the HTML for errors and storing results in the database, and formulating a new HTTP communication based upon the received HTML and the test configuration file. The test configuration file is created by sending HTML comprising a blank testing form to a web browser, receiving HTTP from the web browser as a submission from the HTML testing form, and developing the test configuration file from the HTTP.

U.S. Pat. Nos. 6,587,969 and 6,360,332 to Weinberg, et al. disclose a testing tool that automatically records a series of user steps taken during a user session with a transactional server and generates a test for testing the functionality of the server. A user interface allows the user to define verification steps to automatically test for expected server responses during test execution. The testing tool also allows the test author to use a spreadsheet to conveniently specify data sets for running multiple iterations of a test; thus, the user can record a single transaction and then automatically test the transaction with other data sets. U.S. Pat. No. 6,237,006, also to Weinberg, et al. discloses a visual Web site analysis program, implemented as a collection of software components, which provides a variety of features for facilitating the analysis and management of web sites and Web site content. A mapping component scans a Web site over a network connection and builds a site map which graphically depicts the URLs and links of the site. Various map navigation, URL filtering, and dynamic page scan features are provided.

U.S. Pat. No. 6,185,701 to Marullo, et al. discloses an automated client-based web application URL link extraction tool for use in testing and verification of internet web servers and associated applications executing thereon. Requested HTML pages are obtained from the web server and a search is executed extracting all links on the page automatically. The retrieved and extracted data is formatted and output in a common format employable in an input file by multiple test application tools which request, capture, store, verify data returned from, and stress the web servers and associated applications.

U.S. Pat. No. 6,044,398 to Marullo, et al. discloses an Internet website virtual browser application, which automatically exercises and verifies web server applications and scripts by simulating a web browser to request, capture, store, and verify data returned from web servers, discarding data not critical to testing, and saving and reusing retained data for subsequent transactions. Input and links are accepted from a GUI edit field or input data file and GUI edit field options may override server/port definitions without changing input data files. Other features include a log file, a verify option and a smart pass/fail status.

U.S. Pat. No. 5,870,559 to Leshem, et al. discloses a visual Web site analysis program, implemented as a collection of software components, provides a variety of features for facilitating the analysis and management of Web sites and Web site content. A mapping component scans a Web site over a network connection and builds a site map which graphically depicts the URLs and links of the site. Site maps are generated using a unique layout and display methodology which allows the user to visualize the overall architecture of the Web site. Other features include various map navigation and URL filtering, and a dynamic page scan.

U.S. Pat. No. 5,701,139 to Weinbaum, et al. discloses a system for tracking and replicating the operation of a cursor manipulation device in a computer system, wherein the computer system includes a monitor and a cursor manipulation device having an icon representing the location of a cursor on the monitor. The system for tracking and replicating includes recording apparatus for capturing a plurality of data points transmitted by the cursor manipulation device and a first multiplicity of events on the monitor. The datapoints and the events on the monitor occur while the icon travels between a first location and a second location on the monitor and the recording apparatus is also operative to identify the first and second locations.

U.S. Patent Application No. 20040059809 by Benedict, et al. discloses a tool to automatically discover and systematically explore Web-site execution paths that can be followed by a user in a Web application. Unlike traditional spiders (or crawlers) that are limited to the exploration of static links, the system can navigate automatically through dynamic components of Web sites, including form submissions and execution of client-side scripts. Whenever examining a new Web page, the system determines all possible actions a user might perform and executes them in a systematic way.

U.S. Patent Application No. 20030005044 by Miller et al. discloses a method and system for testing and analyzing websites via a test-enabled web browser. In the representative embodiment a user controls a test-enabled web browser via a set of pull-down menus, choosing between alternative testing and analysis functional capabilities, selecting files in which to store recordings (scripts), choosing files into which to place test results and messages, and setting various parameters that affect how the testing and analysis functions are performed.

Although all of the aforementioned prior art examples address web testing and/or monitoring tools, they require knowledge and training in the application to execute the tests. The present invention, on the other hand, combines methods of testing in a novel tool that can be used with no technical training beyond basic computer literacy.

Therefore, it would be advantageous over the prior art to provide a client-based web server application verification and testing system that requires no technical training, yet provides effective and efficient automated testing.

### SUMMARY OF THE INVENTION

Accordingly, it is the aim of the present invention to provide a client-based web server application verification and testing system.

It is another object of the present invention to provide a client-based web server application verification and testing system that requires no technical training.

It is a further object of the invention to provide a client-based web server application verification and testing system that facilitates the rapid generation of test cases for a web site.

It is yet another object of the invention to provide a client-based web server application verification and testing system that facilitates the automated execution of test cases via distributed computing.

It is yet another object of the invention to provide a client-based web server application verification and testing system that provides flexibility.

The above objects are accomplished by providing a client-based web server application verification and testing system that combines different methods of web testing in one tool that requires no technical training on the part of the user. The invention facilitates the rapid generation of test cases for a web site, and the automated execution of those test cases via distributed computing. The transitions through a web site are mapped onto a tree control to exploit user familiarity with a dual pane graphical interface and the drag/drop operation on tree controls. The tree is populated primarily by an autonomous spider exploring the site. Complex sequences requiring form inputs are added by recording sample sequences and then allowing the user to prune from all possible permutations of those samples. The export and import of form input data to a spreadsheet provides additional flexibility. Both the exploration and validation tasks may be distributed to a network of computers.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 shows the present invention's preferred embodiment in a network of distributed PCs.

FIG. 2 shows the test controller user interface.

FIG. 3 shows the display of the permutation engine.

FIG. 4a shows an example export file

FIG. 4b shows a simplified export file.

FIG. 4c shows a simplified import file with fourth value varying.

FIG. 4d shows a simplified import file with third value varying.

FIG. 4e shows descendent nodes duplicated on import.

FIG. 4f shows import with leading columns deleted.

FIG. 5 shows a simplified e-commerce page with several action buttons.

FIG. 6 shows the test controller tree with a group node.

FIG. 7 illustrates a drag/drop operation to create new test cases.

FIG. 8 shows the result of FIG. 7 drag/drop operation to create new test cases.

FIG. 9 shows the error tree.

FIG. 10 shows a sample report file after unattended execution.

FIG. 11 show context menu.

### DETAILED DESCRIPTION OF THE PREFERRED EMBODIMENTS

The present invention is a client-based web server application verification and testing system that combines different methods of web testing in one tool that requires no technical training on the part of the user.

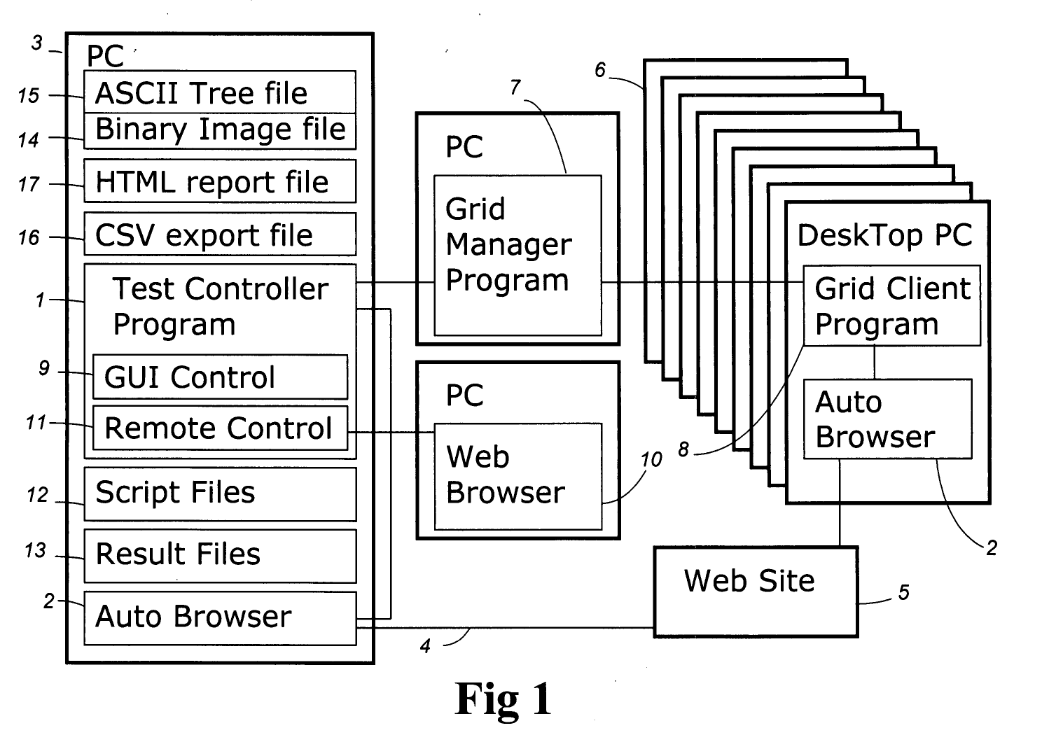

FIG. 1 shows the present invention's preferred embodiment in a network of distributed PCs. The invention comprises a test controller program 1 and an automated browser 2 that together define and execute a set of tests for a web site. The controller program executes in a computer 3 which is connected by a communications link 4 to a website 5. This is the most common minimum configuration, although the website could exists within the same computer as the invention. To use the distributed processing features of the invention, it is connected to multiple computers 6 via a distributed processing framework. In FIG. 1, that framework comprises a server program 7 and a client program 8 running on multiple computers.

In operation, the test controller program 1 interacts with the computer's Graphical User Interface (GUI) 9 for some tasks, and may interact with a common web browser 10 for other tasks. The GUI is used to define a set of tests for the website, to start, stop, and monitor those tests, and to display the results. The optional browser 10 is used to start, stop, and monitor previously defined tests, and to display the results. The remote control module 11 provides an http interface to support remote operation.

Tests are executed by the automated browser 2 that consumes a script file 12 and produces a result file 13. The tests may be executed on the same computer 3 as the test controller 1, or distributed via the framework server 7.

The script files 12 generated by the test controller 1 contain a sequence of mouse actions, key actions, commands, and event checkpoints. The script file 12 may include host file entries that associate an IP address with a URL. These entries would be included to direct the automated browser to a particular web server instance.

The script file 12 may include configuration parameters to control operation of the automated browser 2. One parameter indicates whether pop-up message boxes and alerts should be responded to automatically, i.e., there are no scripted mouse/key actions to acknowledge the alert and continue. Such behavior may be desired when autonomously exploring a web site, but not when replaying a user's recorded steps.

Script file commands include: request an HTTP GET from a given URL, direct the automated browser 2 to scroll a web page position into view, enter a string into a text form input, and select an entry from a select box form input. Event checks include a check that the automated browser is navigating to the correct URL, and a document complete check that the title of the loaded page is correct. Either or both of these two events may specify a wildcard (“*”) if a script is being executed for the first time. On subsequent executions, the script would contain a specific URL and title. An exemplary script file is illustrated below:

OPTION IgnoreURLQueryString=Y

OPTION IgnoreHostsFile=Y

HOSTS_FILE 127.0.0.1 www.deskgrid.com

GO http://www.deskgrid.com

EVT_START_NAV http://www.deskgrid.com/

EVT_DOC_COMPLETE DeskGrid—Grid Computing On Desktop PC's
AUTO_MESSAGE_BOX YES
AUTO_SCROLL 102 618
   BTND 513 134164 102 618 4200
   BTNU 514 134164 102 618 4300
   EVT_START_NAV http://www.deskgrid.com/printable.html
   EVT_DOC_COMPLETE*
   STOP_BUTTON
   EVT_STOP

The result file 13 contains ASCII data required to fully characterize, for each page transition, the automated browser's 2 request to the website 5 and the website's response. File data include the URL requested, any POST data sent, the title of the response page, and a list of all inputs on the response page. For each page transition, the result file 13 includes two compressed images of the browser's main window: the first immediately before a website request, the second when the response is complete. These images are used in the test controller 1 to orient the user within the web site. The images are formatted as run-length encoded 16 color bitmaps. Below is the ASCII portion of an exemplary result file. The IMG1 and IMG2 entries contain file addresses of the images in the accompanying binary file.

finished page=−1

ELM2=

IMG1=193184

RQST=<p><hr><p><b>URL</b><br>C:\tmpdeskgrid\Applications\WebTest\Demo\demo.html<p><b>Post Data</b><br><p><b>Cookie</b><br>

TITL=Test

BROK=Number of Images=0

IMG2=141944

ELEM=ANCH 289 182 81 18 NoScript file:///C:/tmpdeskgrid/Applications/WebTest/Demo/default.html

ANCH 501 200 82 18 NoScript file:///C:/tmpdeskgrid/Applications/WebTest/Demo/browsertest.html

CKIE=

finished page=0

ELM2=ANCH 289 182 81 18 NoScript file:///C:/tmpdeskgrid/Applications/WebTest/Demo/default.html

ANCH 501 200 82 18 NoScript file:///C:/tmpdeskgrid/Applications/WebTest/Demo/browsertest.html

IMG1=141964

RQST=<p><hr><p><b>URL</b><br>http://www.deskgrid.com/<p><b>Post Data</b><br><p><b>Cookie</b><br>

TITL=DeskGrid−Grid Computing On Desktop PC's

BROK=Number of Images=3

IMG2=283656

ELEM=ANCH 511 290 115 18 NoScript http://www.deskgrid.com/tech.html

ANCH 626 290 133 18 NoScript

ANCH 419 327 142 18 NoScript http://www.deskgrid.com/browser.html

ANCH 419 436 102 18 NoScript http://www.deskgrid.com/livexl.html

ANCH 462 509 99 18 NoScript http://www.deskgrid.com/apps.html

ANCH 518 582 89 18 NoScript http://www.deskgrid.com/licenses.html

ANCH 607 582 375 73 NoScript

ANCH 538 637 126 18 NoScript http://www.deskgrid.com/release.html

ANCH 43 510 44 18 NoScript http://www.deskgrid.com/news.html

ANCH 43 528 71 18 NoScript http://www.deskgrid.com/tech.html

ANCH 43 546 89 18 NoScript http://www.deskgrid.com/release.html

ANCH 43 564 70 18 NoScript http://www.deskgrid.com/licenses.html

ANCH 43 582 63 18 NoScript http://www.deskgrid.com/corp.html

ANCH 43 600 118 36 NoScript http://www.deskgrid.com/printable.html

CKIE=

finished page=1

ELM2=ANCH 511 290 115 18 NoScript http://www.deskgrid.com/tech.html

ANCH 626 290 133 18 NoScript

ANCH 419 327 142 18 NoScript http://www.deskgrid.com/browser.html

ANCH 419 436 102 18 NoScript http://www.deskgrid.com/livexI.html

ANCH 462 509 99 18 NoScript http://www.deskgrid.com/apps.html

ANCH 518 582 89 18 NoScript http://www.deskgrid.com/licenses.html

ANCH 607 582 375 73 NoScript

ANCH 538 637 126 18 NoScripthttp://www.deskgrid.com/release.html

ANCH 43 510 44 18 NoScript http://www.deskgrid.com/news.html

ANCH 43 528 71 18 NoScript http://www.deskgrid.com/tech.html

ANCH 43 546 89 18 NoScript http://www.deskgrid.com/release.html

ANCH 43 564 70 18 NoScript http://www.deskgrid.com/licenses.html

ANCH 43 582 63 18 NoScript http://www.deskgrid.com/corp.html

ANCH 43 600 118 36 NoScript http://www.deskgrid.com/printable.html

IMG1=284140

RQST=<p><hr><p><b>URL</b><br>http://www.deskgrid.com/printable.html<p><b>Post Data</b><br><p><b>Cookie</b><br>

TITL=News

BROK=Number of Images=1

IMG2=108016

ELEM=AREA 10 15 256 39 NoScript http://www.deskgrid.com/default.html

ANCH 43 162 154 18 NoScript http://www.deskgrid.com/summary.html

ANCH 43 199 166 18 NoScript http://www.deskgrid.com/summary mgr.html

ANCH 43 236 540 18 NoScript http://www.deskgrid.com/summary apps.html

ANCH 43 273 253 18 NoScript http://www.deskgrid.com/summary_wtb.html

CKIE=

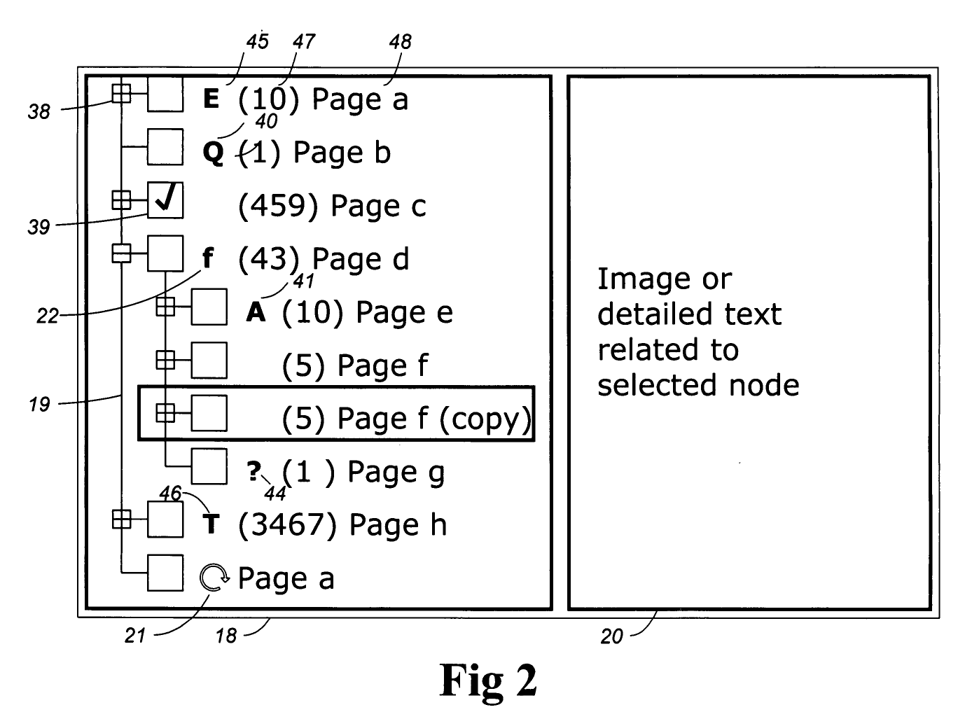

A set of tests is archived as a pair of files: a binary image file 14 and an ASCII file 15 containing all the data required to completely restore the state of the test controller 1. Archived data include the before and after images for each page transition, and the tree structured representation of the web site tests described below in reference to FIG. 2. Archived images are in the same format as the images in the result file. Below is a fragment from an ASCII archive file defining four nodes. Each node definition starts with URL and ends with STOP. Indentation indicates the parent/child relationship:

DOC OPTIONS 0 0 1

HOSTS FILE 127.0.0.1 www.deskgrid.com|

IGNORE PARAMS DG_TIME_STAMP|

URL

STATE 1 0 0 0 0 0 0 0 0 0

DATA 0 0 0 0 0 0

STOP

URL http://www.deskgrid.com

TITLE DeskGrid—Grid Computing On Desktop PC's

RQST

COOKIE

BADIMAGES Number of Images=3|

NICKNAME DeskGrid—Grid Computing On Desktop PC's

STATE 2 1 0 0 0 0 0 0 0 0

DATA 0 142268 142268 283940 426208 841

INPUT0 0 0 0WALK0

INPUT_NAME GRP1

STOP

URL http://www.deskgrid.com/tech.html

TITLE Technology

RQST

COOKIE

BADIMAGES Number of Images=2|

SCRIPTSTEP AUTO_MESSAGE_BOX YES|AUTO_SCROLL 568 299|BTND 513\134164 568 299 2000|BTNU 514 134164 568 299 2100|EVT_START_NAV\http://www.deskgrid.com/tech.html|EVT_DOC_COMPLETE Technology|

NICKNAME Technology

STATE 3 1 0 0 0 0 0 568 299 0

DATA 427049 283940 710989 282876 993865 137

INPUT 0 0 0 0 WALK 0

INPUT_NAME GRP1

STOP
URL http://www.deskgrid.com/default.html
TITLE*
SCRIPTSTEP AUTO_MESSAGE_BOX YES|AUTO_SCROLL 138 34|BTND 513\134164 138 34 4400\BTNU 514 134164 138 34 4500|EVT_START_NAV\http://www.deskgrid.com/default.html|EVT_DOC_COMPLETE*|
STATE4 0 0 0 0 0 0 138 34 0
DATA 994002 0 994002 0 994002 0
STOP
URL http://www.deskgrid.com/architecture.html
TITLE*
RQST
COOKIE
BADIMAGES Number of Images=2|
SCRIPTSTEP AUTO_MESSAGE_BOX YES|AUTO_SCROLL 407 285|BTND 513\134164 407 285 4600|BTNU 514 134164 407 285 4700|EVT_START_NAV*\|EVT_DOC_COMPLETE*|
STATE 5 0 0 0 0 0 0 407 285 0
DATA 994002281816 1275818 129508 140532665
INPUT 0 0 0 0 WALK 0
INPUT_NAME GRP1
STOP

The test controller 1 may optionally export and/or import an ASCII file 16 in comma separated values (CSV) format. Each row of the CSV file represents one path within the web site, and contains the form inputs (if any) provided to each page in order to get to the next page. The CSV file may be manipulated by a spreadsheet or other utility program. Export/import operations are useful to easily create new tests by varying some input values from an existing test. For example, a sequence of pages may be duplicated for different login name and password combinations.

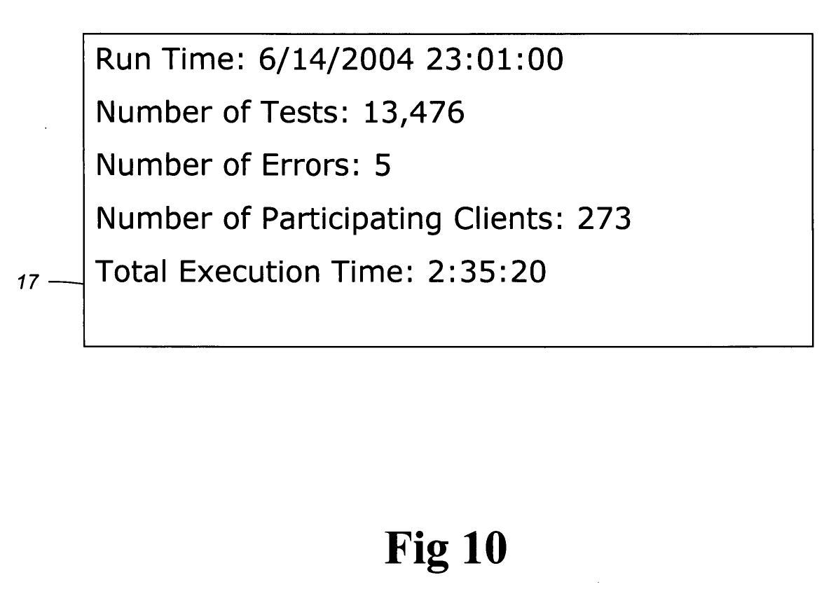

An HTML report file 17 shows the summary results from running a suite of tests. The report file 17 is useful when execution of a set of tests is unattended. FIG. 10 illustrates an exemplary report file.

FIG. 2 shows the test controller GUI 18 comprising two panes: a tree control 19 (e.g. Microsoft's TreeCtrl), and a details pane 20. This combination is widely used and minimizes the training required to manipulate data. The invention represents a series of website page transitions as a cascade in the tree control. The indentation level corresponds to the position of a page transition in the test's sequence.

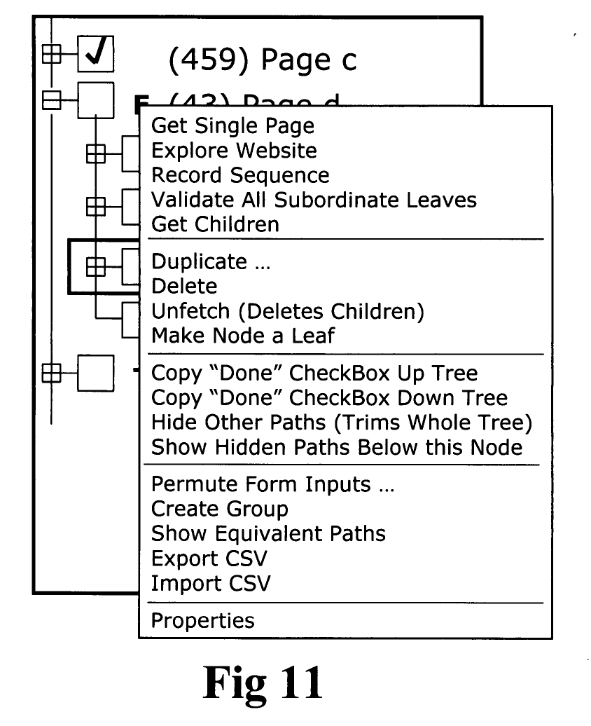

The transition from one page to another can be automated by a script fragment executed by an automated browser 2. A simple script comprises a sequence key and mouse actions. Tree nodes with a common parent share all script file steps required to reach their parent. Their script files then diverge to invoke their unique page transition. Any node in the tree is by definition a test case, in that the sequence of script fragments defined by its position in the tree should produce the same result page when executed. The user can execute a test case by selecting a node and selecting a command from a context menu 61 (FIG. 11). Tree leaves define the minimal set of tests that will execute all defined transitions. The intermediate transitions through the leaves' ancestors are not required to be separate tests.

In the case of a web site with no form inputs on any page, the test controller executes like a classic web spider, automatically exploring all possible links on each page. In such cases, an exhaustive search is feasible and a complete transition tree is built without user intervention. Because web sites may contain circular reference chains, the test controller detects when a page request has already been represented in the tree. Such redundant requests are flagged as loops 21 and the search continued without entering the loops. If the user understands that due to website state, the request isn't really redundant, he may remove the loop designation from the node so that the search algorithm will proceed down that path.

Having checkbox and select inputs on one or more pages may increase the number of possible test cases so that an exhaustive test of all possible input combinations is not feasible in a reasonable time. Much worse is the introduction of text inputs, which produce combinatorial products that make a complete test practically impossible. The user must make some assumptions or deductions about what features of text inputs will result in different processing paths in the website. Examples of such text inputs include text strings less than or greater than a particular length, strings containing unusual characters, user names that are recognized as valid by the website, user names that are not recognized as valid by the website, addresses that are valid (street address consistent with postal code), etc. In addition to externally visible differences, many applications exhibit state behavior that multiplies complexity. Valid user names can map to internal data producing combinatorial processing states that could number in the millions, e.g., credit card numbers, home address, user preferences, previous transactions.

The problem of completely testing websites with form inputs is therefore often intractable. The best one can do is to apply knowledge of the website's application logic to reduce the test set and use automation to maximize testing efficiency.

The present invention facilitates this process by completely automating creation of tests that do not require form inputs, and optimizing the creation of those that do. The user first instructs the test controller to explore the web site. The controller will fetch a page, add child nodes for each action on that page, and continue until the web site has been completely explored (except for actions requiring form inputs). This will build a tree with some nodes flagged 22 as accepting form inputs. The user then records sample test paths containing the flagged pages. For example, a purchasing site sample would include a path through the site with a valid name, address, payment method, product selection and shipping instructions. This path will typically include several pages. The user can start a recording session by selecting any node in the tree and issuing the “Record Sequence” context menu command. The controller 1 builds a script leading the automated browser 2 up to the selected page, whereupon the user is prompted to start recording further actions. On completion of the recording session, the automated browser 2 passes back a result file 13. From this file, the controller attaches a new descendent path to the selected node in the tree control, with one additional node for page transition recorded.

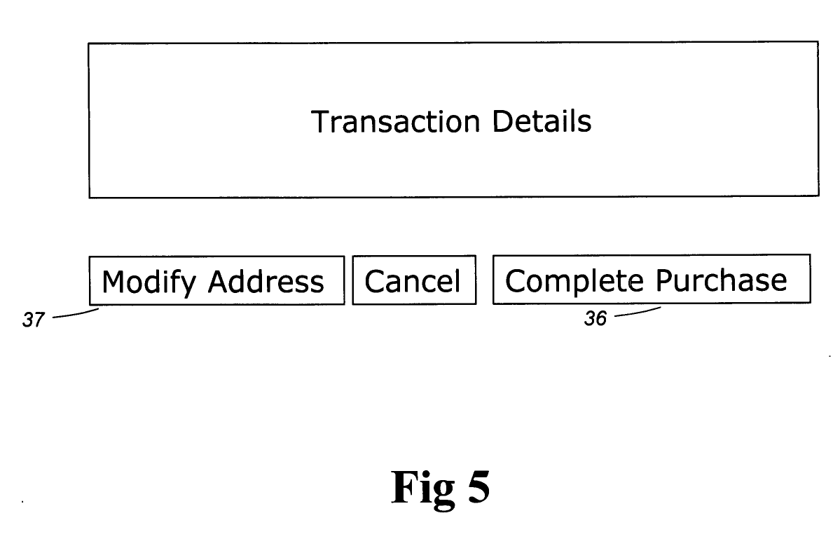

A single recorded path through a site can generate a huge number of test cases. As shown in FIG. 5, typical e-commerce pages contain multiple action buttons or links, only one of which 36 moves the user forward through a transaction flow. Examples include: actions to go back to a previous page, actions to cancel the transaction, actions to modify previously entered data 37. After a sample path is recorded, the test controller 1 will automatically generate the test cases that select each of these alternate actions on each of the pages visited. If new form date is required on any of the resulting pages, the corresponding tree node is flagged 22 (FIG. 2).

The recording of paths containing form inputs is time consuming, so the test controller 1 supports two means of multiplying these recorded samples into sufficiently broad test coverage: a permutation engine, and the export to and import from a spreadsheet.

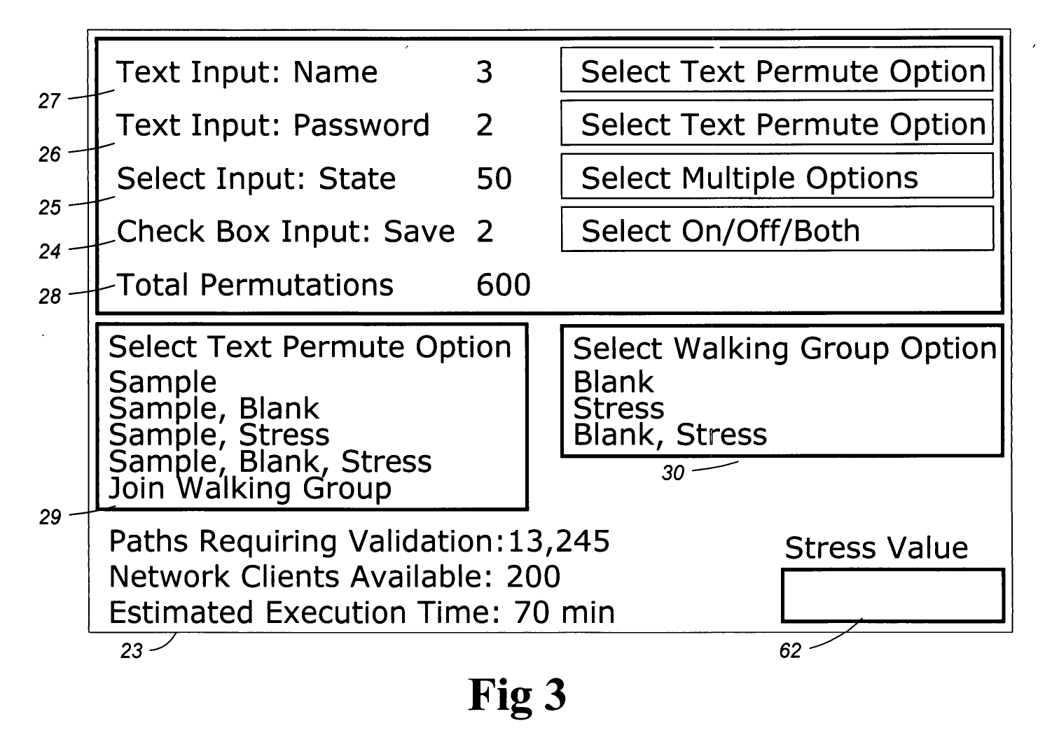

FIG. 3 shows the display 23 of a permutation engine for a page containing two text inputs, one select input and one check box. The permutation engine allows the user to interactively constrain inputs to achieve the desired trade-off between test coverage and test execution time. The user interactively constrains each input on a page until an acceptable number of permutations 28 are reached. Checkbox 24 and select input 25 permutations are obvious, and radio button permutations (not shown) only slightly more complex. However, text permutations 26, 27 create virtually infinite combinations unless constrained. The engine allows a text input to vary among limited choices 29: a recorded or manually entered sample value, a blank (empty) value, or a user-specified stress value 62.

Alternatively, a text input can be assigned to a walking group 30 and the blank and/or stress values stepped through each member of the group. In each combination, only one member of the walking group would get a blank or stress value, all others would have the sample value.

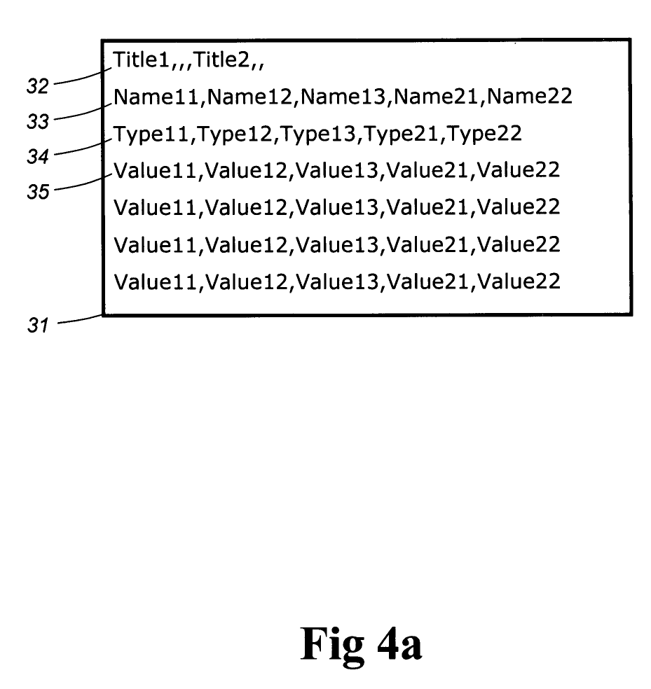

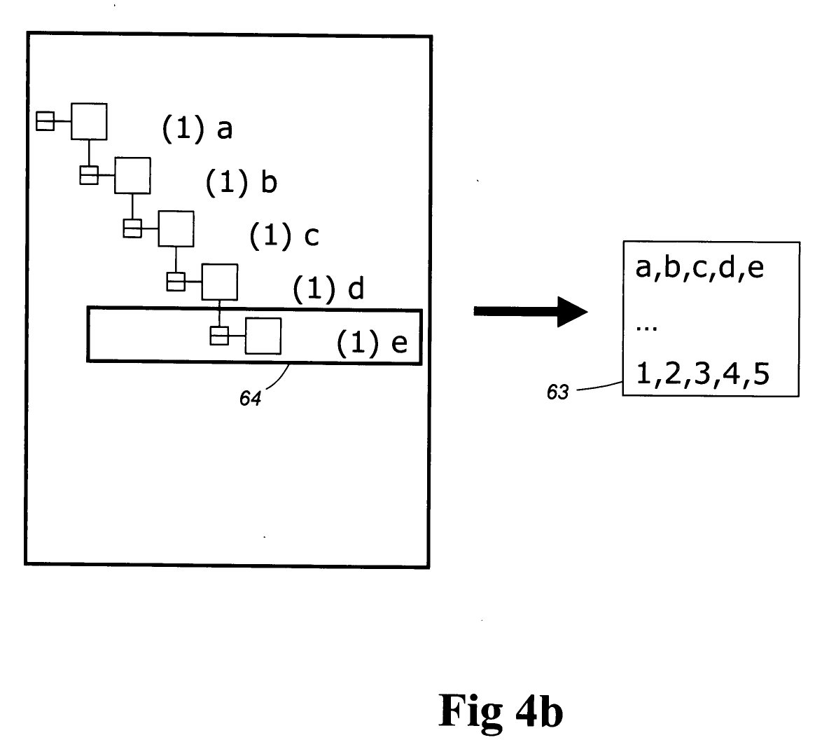

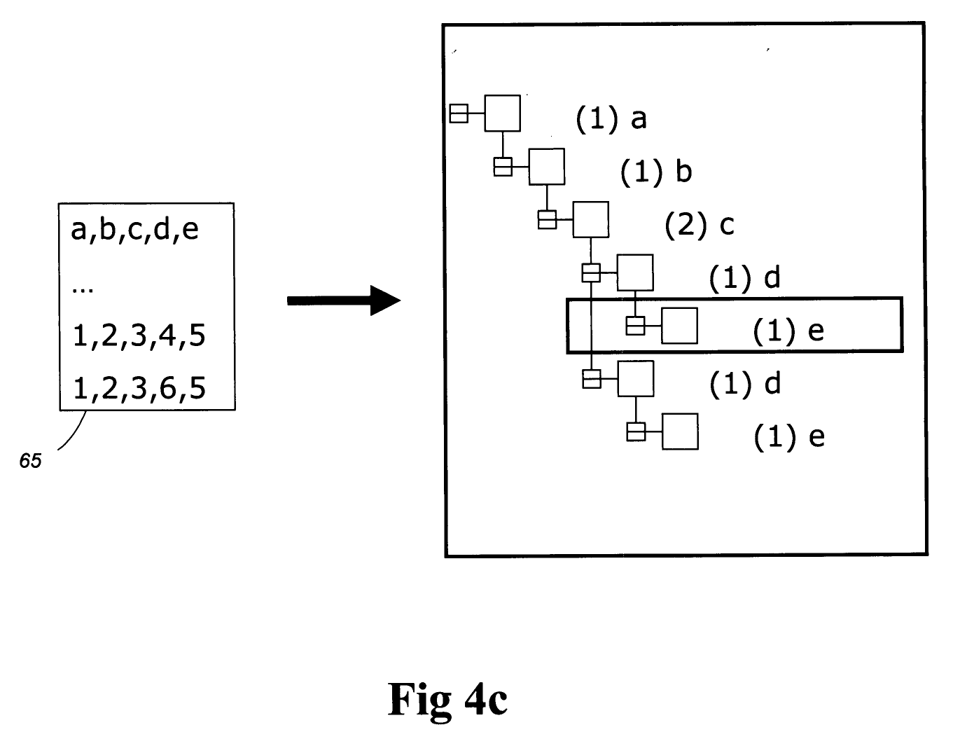

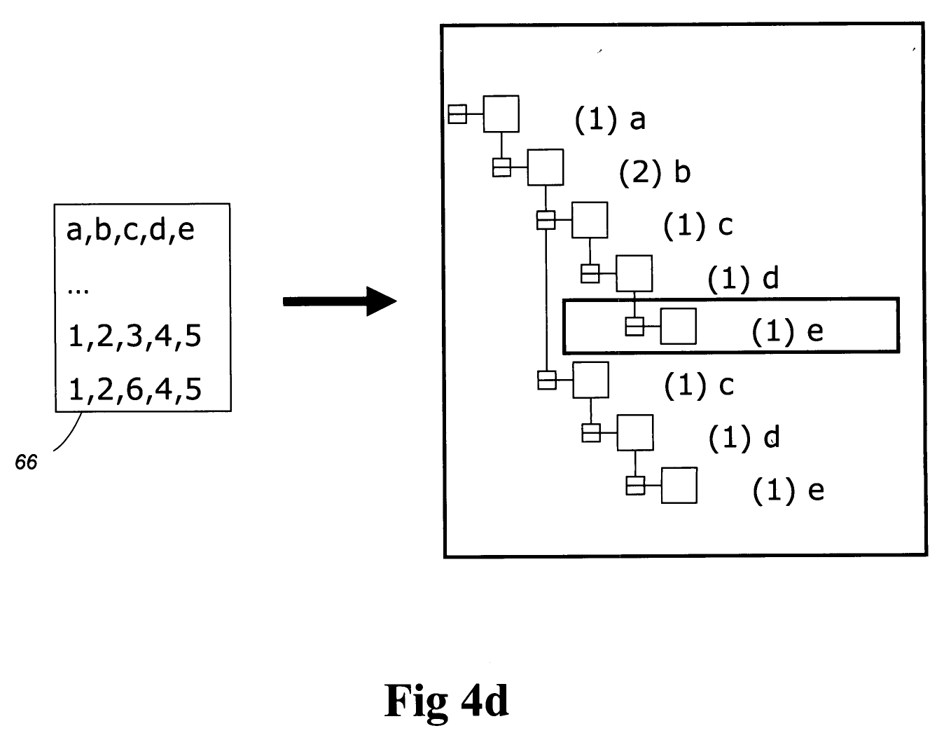

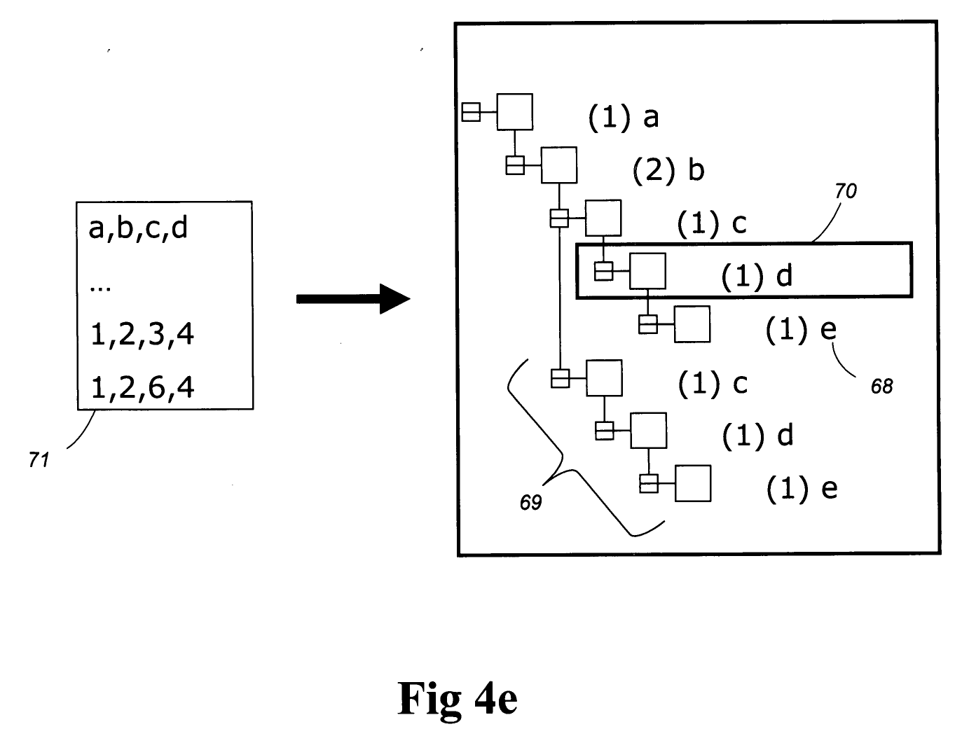

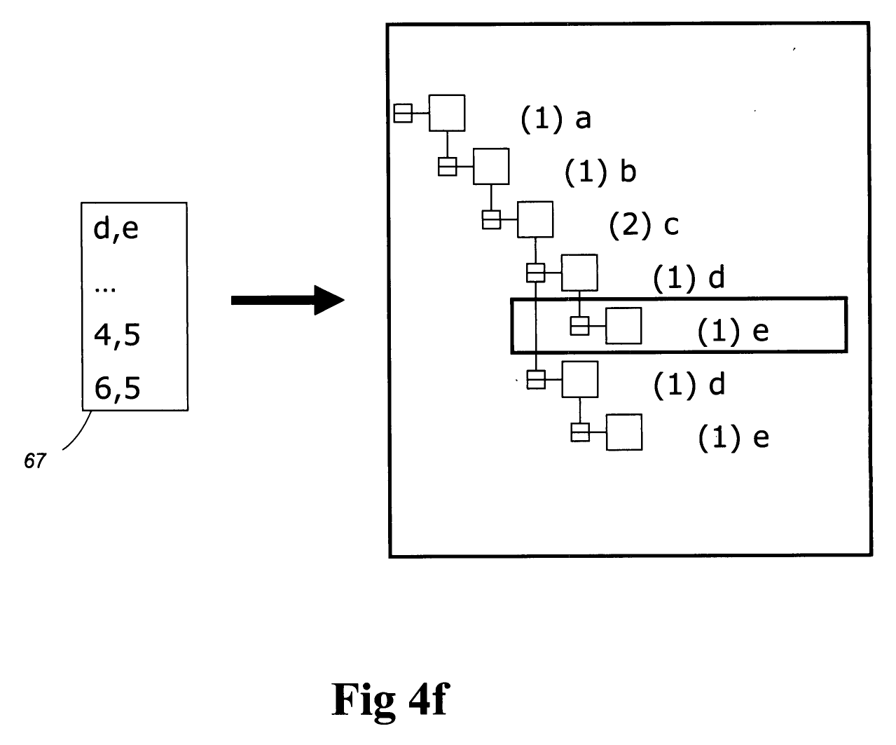

The second method of multiplying a recorded sample is to export the inputs from each page in the path into a single csv file. FIG. 4a shows an exemplary export file 31 comprising three headers lines and four data lines. Interpreted as a matrix, each column corresponds to a field input. The first line 32 lists the title of each page in the sequence, followed by a comma for each input on that page. The second line 33 contains the field name for each input. The third line 34 contains the type of input (text, select, check box, or radio). A data row 35 contains the value for each input.

FIG. 4b shows a simplified export file 63 (showing the title row and data for one input per page) created from a selected node 64. The export file can be imported into a spreadsheet or other tool and manipulated to create an arbitrarily large set of test cases. The resulting csv file is then imported into the test controller 1, which creates new paths for each new or changed line of the csv. FIG. 4c shows an import 65 where the fourth column varies and FIG. 4d shows an import 66 where the third column varies. Note that new paths maintain common nodes with the selected path as far down as possible, i.e., until a different input value is read. This minimizes the complexity of the tree without restricting the number of test cases (paths).

The node selected for the import does not have to be one which created an export file. As long as the file's page titles match the path to the selected node, the import will create new paths equivalent to the selected node's path regarding transition actions (e.g. which button is pressed). The new paths will vary from each other by form input values. This feature allows a csv file to be imported in the context of multiple nodes, quickly creating large number of test cases.

When import creates new paths, the entire descendent tree of the selected node is reproduced. FIG. 4e shows page titled “e” 68 is duplicated when a new path 69 to selected node “c” 70 is created by an import 71.

Another example would be a two page path comprising a log-in page and a second page with many possible actions. The following sequence could be used to create test cases. Step1: record a sequence logging in and proceeding to the second page. Step 2: explore website from the second page, building a descendent tree based on the actions. Step 3: export a file from the login page. Step 4: with the login page selected, import a csv file containing multiple login names. The entire descendent tree would be duplicated for each login name.

FIG. 4b illustrated the export command creating the csv file 63 with one column for each page from the top of the tree. FIG. 4f shows how the import command will accept csv files representing fewer pages 67. Pages are matched from right on left and from the selected node up the tree. One or more left-most pages may be omitted if you want the import to use the top nodes in the selected path (as would happen if the input values for those pages were present and all matched). The user may also delete some columns from a page in the csv file 63. The missing input values are assumed to match those in the selected path.

We now refer back to FIG. 2. Consistent with common tree representations, an expansion box 38 containing either a plus or minus sign is shown when a node in the tree has descendents. A plus indicates expansion when the box is clicked; a minus indicates collapse when the box is clicked.

Each node in the tree is decorated with symbols and letters characterizing the corresponding page. A checkbox 39 indicates whether the page has been validated. Certain execute modes will skip pages (and descendent paths) if the node is checked. This allows test runs to be interrupted and continued without redundant test case executions. Commands facilitate setting or clearing the check boxes of groups of nodes. See FIG. 11 for a detail description of these commands.

To the right of the checkbox 39 is a single character field containing one of several flags. The loop indicator 21 has been previously addressed. An upper case “Q” 40 indicates a test path terminating at that node has been queued for execution. An upper case “A” 41 indicates a previously queued test path is currently being executed by the automated browser, either locally or remotely. A lower case “f” 22 indicates that the page contains form inputs for which the user has not provided values. An upper case “F” indicates that the page has form inputs for which the user has provided values. A question mark “?” 44 indicates that the page has not yet been requested from the website. An upper case “E” 45 indicates a validation error occurred the last time the path was executed. An upper case “T” 46 indicates a timeout occurred the last time the path was executed.

To the right of the single character field, is the number of leaf nodes 47 that are descendents of the displayed node. A leaf node has no descendents. This leaf node count is displayed in parentheses to clearly delimit the node identifier 48 to its right. This text string displays one datum of the associated page. In various display modes, this string may be the URL from which the page was requested, the HTML Title of the page, or a nickname given by the user.

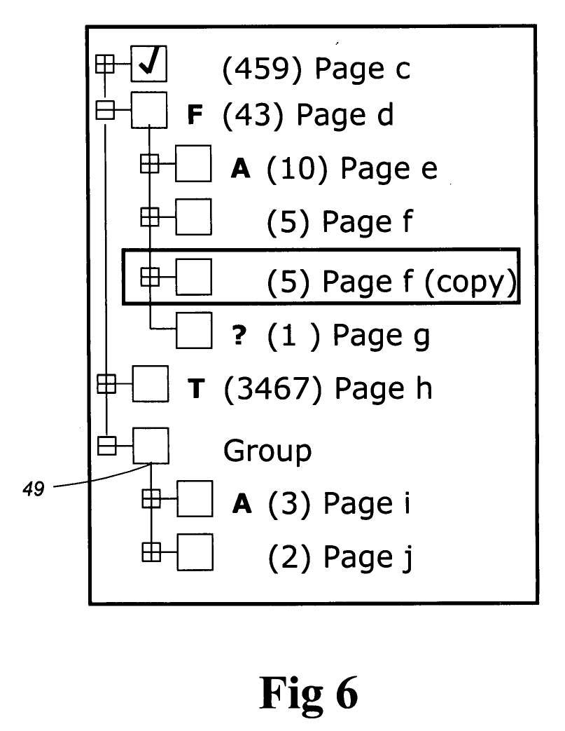

Each page transition modeled by the test controller has a corresponding node in the tree. The order of descent, or path, from the top of the tree corresponds to the order of page transitions in the represented tests. To facilitate management of a large number of paths, two techniques modify the one-to-one mapping of web pages to tree nodes: group nodes, and hidden paths. As shown in FIG. 6, group nodes 49 in a tree have no corresponding web page. They are created to allow a set of descendent paths to be manipulated as a unit. Examples of manipulation include duplication, moving to other parts of the tree, and control of validation by a single check box—that of the group node. Hidden paths are series of page transitions whose mapping to the tree is temporarily suppressed to highlight the remaining paths. An example use is a search command, which hides all paths not meeting specified search criteria (URL, Title, error status). A context menu command restores the visibility of all hidden paths below a selected node.

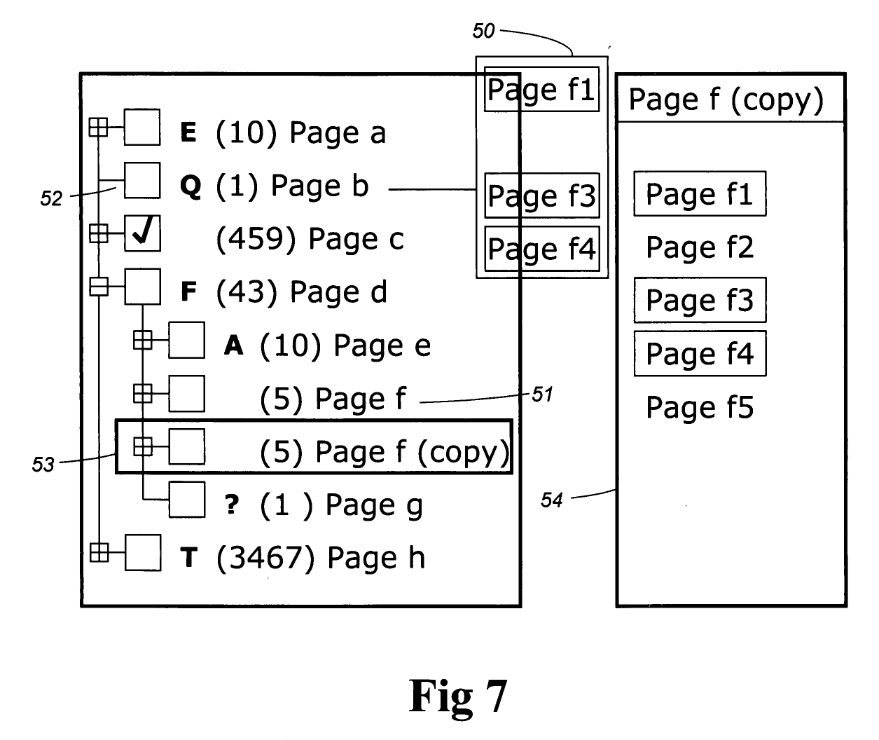

FIG. 7 shows a drag and drop operation moving a set of nodes 50 (and their descendents) from one place in the tree to another. If the user has defined a number of transitions following “Page f” 51, and finds some of those transitions are also useful following “Page b” 52, he could first duplicate the node for “Page f”, creating “Page f (copy)” 53. He could then display the children of the “Page f (copy)” in the right pane 54.

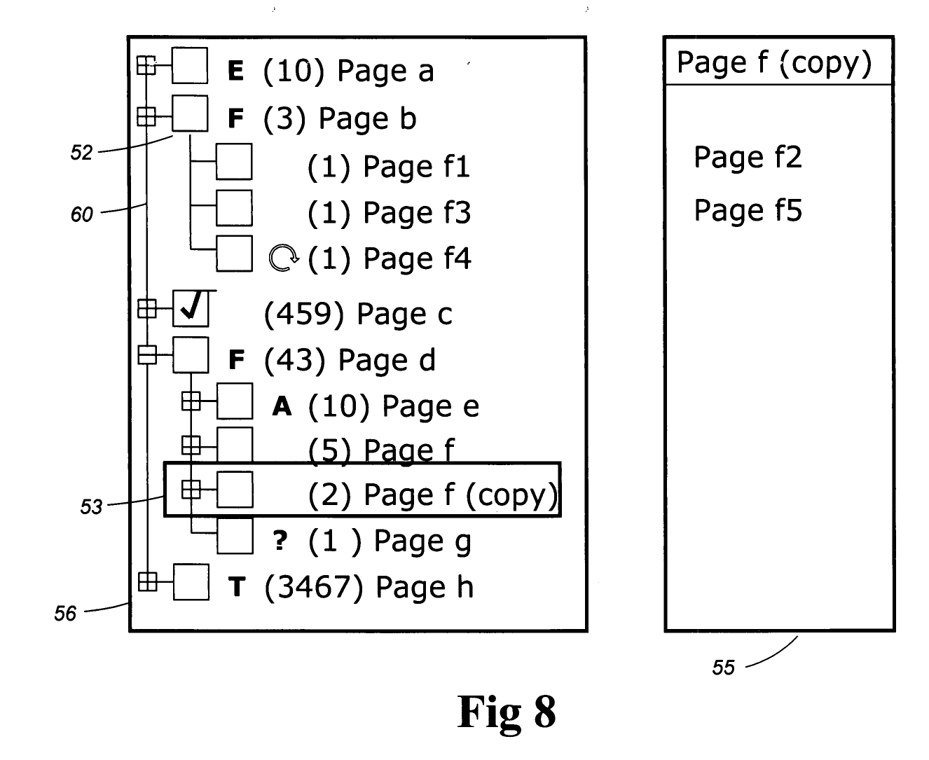

Finally, the user would drag and drop selected child nodes to the node for “Page b” 52. The resultant tree structure 60 is shown in FIG. 8.

Drag and drop operations are supported from the right pane 55 to the left pane 56, or within the left pane. If the user wished to copy all transitions under “Page f (copy)” 53, he could drag “Page f (copy)” to “Page b” 52 within the left pane.

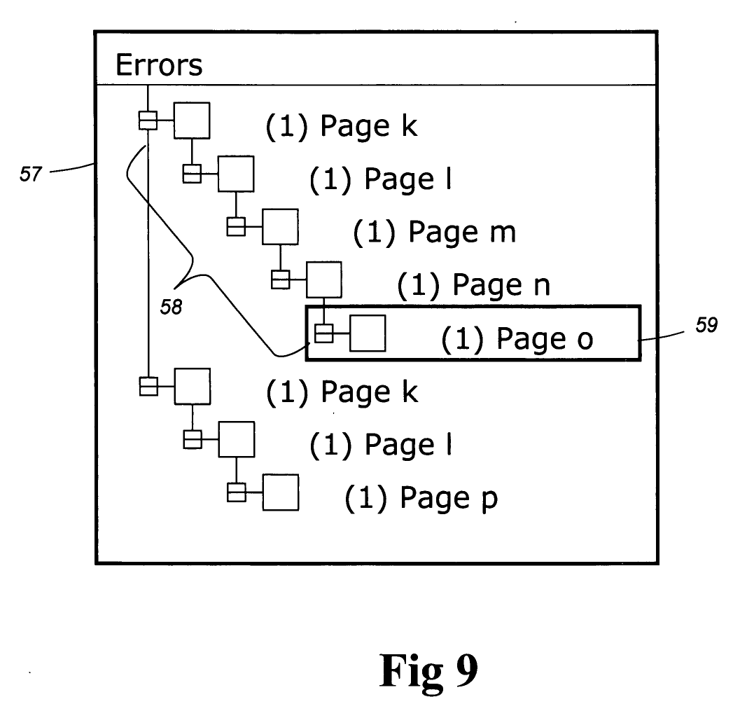

FIG. 9 shows the error tree 57. When a validation fails, the node in the primary tree is marked 45 (FIG. 2) to show that an error has occurred. The detailed results of the validation attempt are shown as a path 58 in the error tree 57. The error tree's path may be shorter than the requested validation's path, e.g., a ten transition validation may fail in the sixth step. To facilitate error inspection, when an error-flagged node in the primary tree is selected, the corresponding node in the error tree is automatically highlighted 59 and scrolled into view. Likewise when a node in the error tree is selected, the corresponding requested validation's node is highlighted in the primary tree and scrolled into view.

FIG. 10 shows sample contents of the html report file 17. This data summarizes the results of an overnight run of previously defined tests. After a run, the controller data is archived to the ASCII Tree file 15 and Binary Image file 14. A user can open these files within the controller to inspect any errors.

FIG. 11 shows the context menu available when a user right-clicks on a node in the tree. “Get Single Page” fetches only the selected node (and in the process its ancestors). Fetching is the process of building a script for the automated browser, invoking the browser, and processing the result file. If the node has never been fetched, the Title, images, and all child nodes are extracted from the result file and added to the tree. If the node has been fetched before, the results are compared to previous results and any differences are flagged as an error (images are for user orientation and are not compared).

Whenever a fetch matches the previous fetch, the validated (or “done”) checkbox is checked. “Get Single Page” unconditionally fetches the node, whether “done” is already checked or not.

“Explore Website” is the spider function. It fetches the selected node, then its children, then their children, etc. It is conditional on the “done” checkbox. A node won't be fetched unless its checkbox is cleared, and all its ancestors' checkboxes are cleared.

This command will skip nodes that have been previously fetched (see “Unfetch” command below”).

“Record Sequence” results in the automated browser 2 fetching the selected node, then prompting the user to record a sequence of page transitions including form field inputs. When the recording is complete, a new descendent path is added below the selected node. “Record Sequence” is unconditional.

“Validate All Subordinate Leaves” fetches all leaf nodes below the selected node. It is conditional on checkbox status. In addition to updating the tree, this command produces the HTML report file 17. In unattended operation, the controller automatically executes this command against the top node in the tree.

“Get Children” unconditionally fetches the children of the selected node, but does not proceed further down the tree.

“Duplicate” prompts the user for how many duplicates are desired, and then creates duplicate descendent paths with the same parent as the selected node. The duplicates have “(copy)” appended to their nickname.

“Delete” removes a node and its descendents from the tree.

“Unfetch” restores a node to the state before it was first fetched. One effect is that all children are deleted. Another is that the “Explore Website” command will fetch it.

“Make Node a Leaf” deletes any children, and sets a flag that prevents future fetches from adding children. It is used to manually override the automatic determination that a node has no non-loop children.

“Copy ‘Done’ CheckBox Up Tree” propagates the selected nodes checkbox state to all of its ancestors.

“Copy ‘Done’ CheckBox Down Tree” propagates the selected nodes checkbox state to all of its descendents.

“Hide Other Paths” temporarily removes all paths from the tree unless they include the selected node.

“Show Hidden Paths Below this Node” undoes the “Hide Other Paths” effect, but only for nodes below the selected node. Executing this command on the top node restores the entire tree.

“Permute Form Inputs” activates a dialog box (FIG. 3) that allows the user to create permutations of the path terminating at the selected node. These permutations are created by changing the form inputs on the selected node's parent page. The permutations will therefore be siblings of the selected node with regard to page transitions in the website. However, in the tree the permutations are placed under a group node for convenience.

“Create Group” creates an empty group node 49 under the selected node. The user may then drag/drop other nodes into the group.

“Show Equivalent Paths” hides all paths that don't share the same page transition sequence. It is used to highlight all the nodes whose differences are limited to form inputs.

“Export CSV” creates a comma separated value ASCII file, as shown in FIG. 4, for the path terminating at the selected node.

“Import CSV” reads a comma separated value ASCII file, as shown in FIG. 4, and checks that the page transitions from the first line in the file match that of the selected node. For each data row in the file, the controller will create a new node path with the same actions as the selected node's path, but having form inputs taken from the csv file.

“Properties” activates a dialog box that allows the user to modify the nickname, URL, or title of the selected node.

When the selected node is a loop, two additional commands are available:

“Follow Loop” highlights the node that the loop node matches.

“Clear Loop” clears the loop flag, making the selected node eligible to be fetched and have descendents.

Selecting a node in the error tree 57 provides the following context menu commands:

“Delete” deletes the entire error path containing the selected node.

“Accept” makes the error response the new baseline for the requested path. The error path is deleted.

While the context menu commands shown in FIG. 111 are applied to a selected node, the main menu of the controller allows commands that are applied to the entire tree. These include:

“New” creates a new, empty tree.

“Open” loads a tree from a pair of archive files.

“Save” saves a tree to a pair of archive files.

“Hide/Show Loops” toggles whether loop nodes are shown in tree.

“Search” activates a dialog box to search tree for matches to URL, Title, or Nickname, or for nodes flagged as errors. Non-matching paths are hidden.

“Hosts File” activates a dialog box to allow users to associate a URL to an IP address.

“Ignore Parameters”—Activates a dialog box for entering parameters that should be ignored when comparing URL's (e.g., time stamps or serial numbers).

“Use Grid” toggles whether automated browser executes locally or remotely. An exception is that the “Record Sequence” command is always local.

“Left Pane View” controls contents of node identifier (URL, Title or Nickname).

“Right Pane View” controls contents of right pane (List of children, Before Image, After Image, Script Fragment, Post Data, or Response Data).

It should now be apparent that the present invention provides a client-based web server application verification and testing system that requires no technical training, and yet easily facilitates the rapid generation of test cases for a web site as well as the automated execution of test cases via distributed computing.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A client-based web server application verification and testing method comprising the steps of:
executing a test controller module having a graphical user interface, said interface including a visual tree structure having tree nodes;
invoking at least one automated web browser to explore a web site;
generating at least one first script with said test controller, said first script including a plurality of commands, inclusive of mouse and key actions and event check points;
outputting said at least one first script from said test controller module to said web browser for the purpose of executing said plurality of commands on pages of a website;
capturing a first result of said commands executed by said web browser on said pages of the website; and
modifying said tree structure of said test controller module to populate the nodes in accordance with said captured first result.

2. The web server application verification and testing method according to claim 1, further comprising the steps, after said modifying step, of:
reinvoking said at least one automated web browser to explore said web site;
generating at least one second script with said test controller module, said script including a plurality of commands including mouse and key actions and event check points on said pages of the website;
capturing a second result of the commands executed by said web browser on said pages of the website;
detecting web site changes by validating said second result against said first result and outputting the web site changes; and
modifying said tree structure of said test controller module to populate the nodes in accordance with said captured second result.

3. The client-based web server application verification and testing system method according to claim 1, wherein data is associated with each of said tree nodes, said tree node data comprising URL, title, links, and form inputs corresponding to at least one web page.

4. The client-based web server application verification and testing system method according to claim 1, wherein data is associated with each of said tree nodes, said tree node data comprising values of form inputs used to request at least one web page.

5. The client-based web server application verification and testing system method according to claim 1, wherein said graphical user interface comprises a Microsoft Windows® interface.

6 The client-based web server application verification and testing system method according to claim 1, wherein said graphical user interface comprises an X-Windows® interface.

7. The client-based web server application verification and testing system method according to claim 1, wherein said graphical user interface comprises an HTTP connection to a web browser.

8. The client-based web server application verification and testing system method according to claim 1, wherein said captured first result is stored within a result file.

9. The client-based web server application verification and testing system method according to claim 1, wherein said first script is stored within a script file.

10. The client-based web server application verification and testing system method according to claim 2, wherein the step of outputting said web site changes further comprises display via said graphical user interface.

11. The client-based web server application verification and testing system method according to claim 2, wherein the step of outputting said web site changes further comprises writing said web site changes to a summary file.

12. The client-based web server application verification and testing system method according to claim 11, wherein said summary file is formatted in HTML for display by a browser.

13. The client-based web server application verification and testing system method according to claim 3, wherein said tree node data include an image of a rendered page immediately after loading.

14. The client-based web server application verification and testing system method according to claim 13, wherein said image is formatted as run-length encoded 16 color bitmap.

15. The client-based web server application verification and testing system method according to claim 1, wherein said tree node data include an image of a rendered page immediately before a subsequent browser page transition.

16. The client-based web server application verification and testing system method according to claim 15, wherein said image is formatted as run-length encoded 16 color bitmap.

17. The client-based web server application verification and testing system method according to claim 1, wherein said graphical user interface comprises two panes, including a tree control and a details pane.

18. The client-based web server application verification and testing system method according to claim 1, wherein the step of modifying said tree structure of said test controller module to populate the nodes in accordance with said captured result further comprises the steps of exporting and importing an ASCII file in comma separated values (CSV) format, wherein each row of said CSV file represents a path within a web site.

19. The client-based web server application verification and testing system method according to claim 18, wherein said CSV file is manipulated by a spreadsheet.

20. The client-based web server application verification and testing system method according to claim 18, wherein said CSV file contains form inputs.

21. The client-based web server application verification and testing system method according to claim 1 further comprising the step of connecting to a web site via a communications link.

22. The client-based web server application verification and testing system method according to claim 1 wherein said at least one automated web browser executes on the same computer as said test controller.

23. The client-based web server application verification and testing system method according to claim 1, wherein said at least one automated web browser executes on distributed computers.

24. The client-based web server application verification and testing system method according to claim 3, wherein the said tree node data comprise the URL requested, any data sent with the browser request, the title of the response page, and a list of all inputs on the response of at least one web page.

25. The client-based web server application verification and testing system method according to claim 3, wherein said tree control and said tree node data are archived in at least one file.

26. The client-based web server application verification and testing system method according to claim 1, wherein a series of website page transitions are represented as a cascade in said tree control.

27. The client-based web server application verification and testing system method according to claim 26, wherein the indentation level of said tree control corresponds to the position of a web page transition in a test sequence.

28. The client-based web server application verification and testing system method according to claim 1, wherein said steps of invoking at least one automated web browser further comprises the step of automating the transition from one web page to another web page.

29. The client-based web server application verification and testing system method according to claim 1, wherein said first script comprises at least one script section, said script section comprising commands required to proceed from a parent node's web page to a child node's web page.

30. The client-based web server application verification and testing system method according to claim 26, wherein each node in said tree control is a test case.

31. The client-based web server application verification and testing system method according to claim 26, wherein tree leaves define the minimum number of tests required to execute all defined transitions.

32. The client-based web server application verification and testing system method according to claim 1, wherein no form inputs exist for any web page and said test controller automatically explores all possible links on each web page and populates said tree structure.

33. The client-based web server application verification and testing system apparatus according to claim 1, wherein said first result comprises said automated browser's request to a web site and the web site's response.

34. The client-based web server application verification and testing system method according to claim 1, wherein said step of modifying said tree structure of said test controller module to populate the nodes in accordance with said captured result further comprises the step of providing a permutation engine that allows the user to interactively constrain form inputs to an acceptable number of permutations.

35. The client-based web server application verification and testing system method according to claim 1, wherein said tree structure further comprises group nodes that have no corresponding web page and allow a set of descendent tree paths to be manipulated as a unit.

36. The client-based web server application verification and testing system method according to claim 1, wherein said test controller further comprises hidden paths that are a series of page transitions whose mapping to said tree structure is temporarily suppressed to highlight the remaining tree paths.

37. The client-based web server application verification and testing system method according to claim 1, further comprising the step of importing form inputs such that a new branch of said tree control is created when the values of said form inputs are new.

38. The client-based web server application verification and testing system method according to claim 1, wherein said tree control further comprises a primary tree and an error tree wherein a node in said primary tree is marked when a web page change is detected and the detailed results of the validations attempted are shown as a path in said error tree.

39. The client-based web server application verification and testing system method according to claim 1, further comprising the step of providing a drag and drop operation function to allow the user to move a set of nodes from one place in said tree to another.
